(19) United States
(12) Patent Application Publication
(10) Pub. No.: US 2006/0044482 A1
(43) Pub. Date: Mar. 2, 2006

(54) Bistable display device

(75) Inventor: Myles A. Shaftel, (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/926,904

(22) Filed: Aug. 26, 2004

(51) Int. Cl. G02F 1/133

(52) U.S. Cl. 349/33

(57) ABSTRACT

A bistable display comprising a display element with at least a layer of bistable material, and a humidistat, is described, as well as methods of reducing voltage and controlling contrast in a bistable display using a humidistat. The bistable display including a humidistat has better viewability, consistent power requirements, and lowered power requirements, regardless of external environmental conditions.

### FIELD OF THE INVENTION

Liquid crystal displays including a humidistat are described.

### BACKGROUND OF THE INVENTION

It is known that certain materials require a controlled environment to maintain function, preserve structure, or prevent degradation. Environmental control systems on large and small scales are known for use in a defined space, for example, in structures such as buildings, displays, and packaging materials. Such control systems are designed in each case to provide optimum conditions for the material, object, or people in the defined space.

For example, U.S. Pat. No. 4,749,241 discloses a display case such as those for use in a museum. The display case is used for supporting and viewing of a museum piece, and includes a base providing a lower chamber for a humidity buffer and a transparent cover providing an upper chamber for viewing the piece on display.

Humidistats are used with moisture-sensitive perishable items, such as tobacco, to lengthen shelf life, prevent mold, and control quality. For example, U.S. Pat. Nos. 4,934,524 and 4,997,082 describe the packaging of cigarettes with a humidistat to control the moisture in the packaging material containing the cigarettes.

Other environmental control materials, such as desiccants, can be used to control humidity. For example, electronic displays are known to include a desiccant. U.S. Pat. No. 6,650,392 discloses a hygroscopic solution surrounding a sealed liquid crystal material in a display, wherein the hygroscopic solution prevents moisture from affecting the liquid crystal material.

The use of desiccants in electronics is not desirable because every desiccant has a saturation point beyond which it can no longer absorb moisture, and many desiccants cannot readily give up moisture to the environment. Desiccants therefore are prone to failure by saturation, beyond which they cannot control increases in humidity, and cannot alleviate dry environmental conditions by providing moisture.

Electronic displays work best within a controlled, narrow humidity range. For each electronic display, there is an optimum humidity range to achieve reduced power consumption, good brightness, and legibility. Operating environments for electronic displays can vary with seasons and location of use, such as in the home, in retail businesses, in factories, or in extreme environments, such as deserts, the artic, or marine applications. In an uncontrolled environment, the properties of the display can be altered such that the fixed operating voltage and power of the display device are no longer optimum, affecting the visual performance of the display. Under certain conditions, the display property changes can be irreversible. Deterioration in visual performance of a display can occur after use for long periods of time. For example, relatively small changes in relative humidity over time can shift the operating voltage of a display enough to lower contrast, and can make the display illegible.

Electronic displays, such as liquid crystal displays, electrochromic displays, and electrophorectic displays, are being widely used for display of images, in instrumentation, and for product pricing displays. Current devices that have high contrast are inconsistent over time, require high voltages, or both. Thus, current devices have either low or varying contrast, or high voltage requirements with high contrast and, typically, a short life.

Long life of the display, low power consumption, and good viewability, for example, brightness and contrast, are desired in all applications. In particular, good and consistent contrast, low power consumption, and consistent power consumption are desirable features in a display. For display devices, viewability and power consumption can be affected by environmental conditions. It is desirable to be able to control environmental conditions inside of a display to provide optimum viewing conditions and minimal, consistent power consumption, regardless of external environment. It is desirable to have a bistable display with controlled humidity, power, and contrast.

### SUMMARY OF THE INVENTION

A liquid crystal display comprising a display element including at least a layer of liquid crystals, and a humidistat, is described, as well as methods of reducing voltage and adjusting contrast in a display using a humidistat.

### ADVANTAGES

The display element as described herein can provide, in a wide range of environments, good and consistent contrast over the life of the display, consistent relative humidity within the display, consistent power requirements, or low power requirements, while maintaining good viewability.

### BRIEF DESCRIPTION OF THE DRAWINGS

The invention can be understood with reference to the following drawings:

FIG. 1 is a plot of contrast value versus drive voltage at 33% relative humidity;

FIG. 2 is a plot of contrast value versus drive voltage at 47% relative humidity;

FIG. 3 is a plot of percent reflectance versus drive voltage at 33% relative humidity;

FIG. 4 is a plot of percent reflectance versus drive voltage at 47% relative humidity;

FIG. 5 is a plot of contrast value versus drive voltage at 70% relative humidity; and

FIG. 6 is a plot of percent reflectance versus drive voltage at 70% relative humidity.

### DETAILED DESCRIPTION OF THE INVENTION

It is desirable to control the environment of electronic displays in order to maintain consistent viewability and consistent power requirements. Viewability refers to the contrast, brightness, and legibility of characters and/or symbols of the display element. One way in which the desired features of viewability and power requirements can be achieved is by maintaining a given relative humidity around the display element in a display.

As used herein, the terms “consistent,” “constant,” and the like, when referring to relative humidity, mean that the relative humidity is within +5% relative humidity of the stated value, for example within ±2% of the stated value. As an example, if the stated relative humidity is 70%, constant or consistent relative humidity means the relative humidity may vary from 65-75%, preferably from 68-72% relative humidity.

As used herein, the terms “consistent,” “constant,” and the like, when referring to contrast mean that the contrast value is within a range of +0.1 from the stated contrast value. As an example, if the stated contrast is 4.1, a constant or consistent contrast over the life of a display means the contrast value remains between 4.0 and 4.2 over the life of the display. As used herein, the terms “consistent,” “constant,” and the like, when referring to voltage mean that the voltage used by the display is within a range of +5 from the stated voltage, for example, within a range of +3. As an example, if the stated voltage is 95, a constant or consistent voltage means the voltage remains between 90 volts and 100 volts, preferably between 92 and 98. A display as referred to herein includes a display element and a humidistat. The humidistat can be part of the display element, or can be packaged with the display element to form the display.

The display element can be a rewritable, electronic display element. According to various embodiments, the display element can maintain a desired written message without power. Such display elements can include a bistable material, for example, electrochemical materials; electrophoretic materials, including those manufactured by Gyricon, LLC of Ann Arbor, Mich., and E-ink Corporation of Cambridge, Mass.; electrochromic materials; magnetic materials; and liquid crystal materials. The liquid crystal materials can be twisted nematic (TN), super-twisted nematic (STN), ferroelectric, magnetic, or chiral nematic liquid crystal materials. Chiral nematic liquid crystals can be polymer dispersed liquid crystals (PDLC). Suitable chiral nematic liquid crystal materials include a cholesteric liquid crystal disclosed in U.S. Pat. No. 5,695,682, and Merck BL112, BL118 or BL126, available from EM Industries of Hawthorne, N.Y.

The display element including a bistable material can be formed by methods known in that art of display making. A support for the display element can be any suitable material, for example, glass or plastic. When the support is plastic, it can be flexible, for example, a flexible self-supporting plastic film. “Plastic” means a polymer, usually made from polymeric synthetic resins, which can optionally be combined with other ingredients, such as curatives, fillers, reinforcing agents, colorants, and plasticizers. Plastic includes thermoplastic materials and thermosetting materials. Where a flexible plastic support is used, it can be reinforced with a hard coating, for example, an acrylic coating. The coating can have a thickness of from 1 to 15 microns, for example, from 2 to 4 microns. Various suitable hard coatings can be used, dependent upon the support material, and exemplary coatings can include a mixture of UV-cured polyester acrylate and colloidal silica, known as “Lintec” by Lintec Corporation of Tokyo, Japan, and an acrylic coating sold as Terraping by Tekra Corporation, New Berlin, Wis.

A first conductive layer can be formed on the support by thick film printing, sputter coating, or other printing or coating means. The first conductive layer can include one or more metal oxides. A primary metal oxide can be indium oxide, titanium dioxide, cadmium oxide, gallium indium oxide, niobium pentoxide, or tin dioxide, for example. A secondary metal oxide can also be in the conductive layer, and can be, for example, an oxide of cerium, titanium, zirconium, hafnium and/or tantalum. See U.S. Pat. No. 5,667,853 to Fukuyoshi et al. Transparent conductive oxides that can be used include, but are not limited to, ZnO₂, Zn₂SnO₄, Cd₂SnO₄, Zn₂In₂O₅, MgIn₂O₄, Ga₂O₃—In₂O₃, or TaO₃. According to various embodiments, the first conductive layer can be tin-oxide, indium-tin-oxide (ITO), or polythiophene. The first conductive layer can be an opaque electrical conductive layer formed of metal such as copper, aluminum or nickel. If the conductive layer is an opaque metal, the metal can be a metal oxide to create a light absorbing conductive layer. The first conductive layer can be formed by any known method, including low temperature sputtering techniques and direct current sputtering techniques, such as DC-sputtering or RF-DC sputtering, or printing, depending upon the material or materials of the underlying layer. The first conductive layer can be patterned, for example, into a plurality of electrodes.

A support having a first conductive layer can be coated with a bistable material, or a pre-formed layer of bistable material can be placed over the first conductive layer. The bistable material can be any of those listed herein. According to certain embodiments, the bistable material can be liquid crystals, for example, chiral nematic liquid crystals.

A second conductive layer can be formed over the bistable material. The second conductive layer can be any material as described for the first conductive layer. Application of electric fields of various intensity and duration to the bistable material between the first and second conductive layers can cause the bistable material to change its state from a reflective state to a transmissive state, or vice versa. The bistable material can maintain a given state indefinitely after the electric field is removed.

The second conductive layer can be patterned non-parallel to patterning of the first conductive layer. The intersection of the patterns of the first conductive layer and the second conductive layer forms a pixel. The bistable material in the pixel changes state when an electric field is applied to the bistable material between the first and second conductive layers.

The second conductive layer can be formed as electrically conductive character segments formed over the bistable material layer by thick film printing, sputter coating, or other printing or coating means. The conductive character segments can be formed by etching, ablation, or other removal techniques if the second conductive layer is formed as a contiguous layer. The conductive character segments can be any known conductive material, for example, carbon, graphite, or silver. An exemplary material is Electrodag 423SS screen printable electrical conductive material from Acheson Colloids Company, Port Huron, Mich. The conductive character segments can be arranged to form numbers 0-9, a slash, a decimal point, a dollar sign, a cent sign, or any other alpha-numeric character or symbol.

At least one of the first or second conductive layer can be transparent. For example, the conductive layer on the side of the display element that is viewed can be transparent.

Wherein the bistable material is a liquid crystal material, a dielectric layer such as deionized gelatin can be formed over conductive character segments by standard printing or coating techniques. Via holes can be formed over each conductive character segment by the absence of the dielectric layer over at least a portion of each conductive character segment, or by removing a portion of the dielectric layer over each conductive character segment, for example, by ablation or chemical etching.

Electrically conductive traces can be formed over the dielectric layer by printing or coating techniques. One or more electrically conductive trace can flow through a via hole on formation, making electrical contact with the conductive character segment. The conductive traces can extend from the character segment to an exposed area along a side of the display, where the conductive trace forms a contact pad in the exposed area. The exposed area is an area of the support coated with the first conductive layer.

The contact pads can be any conductive material, for example, silver or carbon. The contact pads can be formed with the conductive traces, or separately therefrom. Contact pads that are not formed with the conductive traces can be coated or printed on the dielectric layer. A via hole can extend from the conductive pad through the dielectric layer to the first conductive layer. The exposed area and the contact pads thereon can be formed along one side of the display, along multiple sides of the display, or in one or more locations on the display not including the conductive character segment. According to various embodiments, the contact pads can be formed in the exposed area along one edge of the display. The contact pads can be placed linearly or grouped, such as in a pattern, for example, a square or rectangle, in the exposed area.

The display element can include a protective layer over the second conductive layer, dielectric layer, or traces. The protective layer can be any material capable of providing environmental protection to the display element. For example, the protective layer can prevent moisture from contacting the display element, can be non-permeable to harmful vapors or fluids, can provide structural protection from damage due to pressure, puncture, or other physical stresses, or a combination thereof. The protective layer can be any material as described herein for the support such as glass or plastic. The protective layer can be a thin film, for example, a polymeric film or metallic film. The protective layer can be transparent, opaque, or opaque with a transparent section corresponding to the display area. The protective layer can be a material with a very low water vapor transmission rate (WVTR) to minimize moisture loss from or absorption into the display element over extended periods of time. Low WVTR materials can be transparent. Suitable materials can be obtained as thin sheets, laminates, or as pellets suitable for molding. Examples of suitable WVTR materials can include SiO₂ sputtered polyethylene sheets, polychlorotrifluoroethylene such as ACLAR Cx™ 8A made by Honeywell, Berkshire, UK, and a laminate of polyolefin and ACLAR Cx™ 8A called ACLAM, also made by Honeywell.

The optical state of the bistable material between the second conductive layer and the first conductive layer can be changed by selectively applying drive voltages to the corresponding contact pad that is electrically connected to the second conductive layer through a conductive trace, or directly to the second conductive layer, and to the first conductive layer by direct or indirect contact. Once the optical state of the bistable material has been changed, it can remain in that state indefinitely without further power being applied to the conductive layers. Methods of forming a liquid crystal display element are known to practitioners in the art, and are described, for example, in U.S. Ser. No. 10/134,185, filed Apr. 29, 2002 by Stephenson et al., and in U.S. Ser. No. 10/851,440 to Burberry et al. Methods of forming other bistable displays including electrochemical materials, electrophoretic materials, electrochromic materials, or magnetic materials, are known in the art.

The display element can be connected to a drive source or a power source by contact with the contact pads. Suitable drive sources and power sources are known in the art, as are various connection methods for each. Power sources can include batteries or direct connections to alternating or direct current sources. Any drive scheme capable of providing a desired voltage to the display element can be used, including, for example, conventional drive schemes, dynamic drive schemes, and hybrid drive schemes. Suitable drive schemes can include, for example, those described in U.S. Ser. No. 10/845,704 to Johnson; U.S. Patent Application Publication Nos. U.S. 2002/0109661 A1 and U.S. 2003/0085863 A1; articles “Simple Drive Scheme for Bistable Cholesteric LCDs,” SID 2001, pp. 882-885, and “Dynamic Drive Scheme for Fast Addressing of Cholesteric Displays,” SID 2000, pp. 818-821, both by Rybalochka et al.; and U.S. Pats. No. 5,251,048; 5,644,330; 5,748,277; 6,154,190; and 6,268,840.

The humidistat material can be any material capable of regulating humidity of the display element within a desired range. The humidistat material can absorb and emit water vapor as needed to maintain the desired relative humidity. The humidistat can prevent liquids from coming into contact with the bistable material. The humidistat can emit liquid in its vapor form. Depending on the desired relative humidity to be maintained around the display element, various materials can be used, including, for example, saturated salt solutions of 80% saturation or more, for example, 90% saturation or more. Use of a saturated salt solution provides a reservoir of moisture, and also maintains the relative humidity at a fixed level despite large fluctuations in relative humidity or moisture transmission, such as through a packaging material. Other suitable materials can include, for example, potassium carbonate, magnesium acetate, sodium acetate, ammonium chloride, ammonium nitrate, and sodium bromide. Suitable humidistat materials can be encapsulated, as described, for example, in U.S. Pat. No. 4,997,082 to Donald Durocher, before use with the display element. Suitable encapsulation materials for the humidistat can have a high water vapor transmission rate.

If environmental conditions surrounding the humidistat material are such that the ambient humidity surrounding the humidistat material is lower than that of the humidistat material, the humidistat material can lose water until the relative humidity of the environment approaches that of the humidistat material. As used herein, “environment” refers to a defined area surrounding the humidistat material. This area can be defined by the inside of a package containing the humidistat material and display element, or by the area bounded by the humidistat material and a display element. If the relative humidity of the environment surrounding the humidistat material is greater than that of the humidistat material, water can be absorbed into the humidistat material and the humidity of the environment can be maintained near that of the humidistat material. The relative humidity of the environment can be maintained at a level dictated by the humidistat material properties.

The display can include a display element and humidistat. The humidistat can be part of the display element, forming an additional layer of the display element. For example, the display element as described herein can additionally include a humidistat material adjacent a conductive layer, on a side of the conductive layer opposite the bistable material. The humidistat material can be separated from the conductive layer by a moisture barrier permeable to water vapor. The moisture barrier can be any material allowing passage of water vapor, but not liquid, between the display element and the humidistat. Through the moisture barrier, the humidistat can provide moisture to, or remove moisture from, the display element to maintain a constant relative humidity of the display element. The humidistat can be adjacent the support of the display element on the side opposite the first conductive layer. The support can function as a moisture barrier, or a moisture barrier can be added to either side of the support between the humidistat material and the first conductive layer. According to various embodiments, the humidistat material, the moisture barrier, or a combination thereof, can be the support of the display element.

When the humidistat is part of the display element, the humidistat can be at least peripherally attached to the display element. The peripheral attachment along the edges of the display element and humidistat prevent moisture in the form of liquids or vapors from contacting, entering, or leaving the display element other than through the humidistat material. The peripheral attachment can be by adhesive, chemical bonding, heat welding, physical protection such as encapsulation by a film or packaging material, or other suitable methods of forming moisture-proof bonds between materials.

The display can include a packaging material. The packaging material can be adjacent at least a portion of the display element, the humidistat, or both, forming a package including at least the display element and humidistat material. The package can be formed by addition of a second support which contacts the support of the display element outside of and surrounding the display area of the display element. The package can be formed by a film attached to the support outside of and surrounding the display area of the display element. A material can form a package by completely surrounding the display element and humidistat. The packaging material can be transparent, opaque, or opaque with a transparent section corresponding to the display area. The packaging material can be a material with a very low water vapor transmission rate (WVTR) to minimize moisture loss from the package, and absorption of moisture into the package, over extended periods of time. The packaging material can be transparent. The packaging material can be obtained as thin sheets, laminates, or as pellets suitable for molding. Examples of suitable WVTR materials can include SiO₂ sputtered polyethylene sheets, polychlorotrifluoroethylene such as ACLAR CX™ 8A made by Honeywell, Berkshire, UK, and a laminate of polyolefin and ACLAR CX™ 8A called ACLAM, also made by Honeywell. Suitable packaging materials can include polymeric films, metallic films, plastic, glass, ceramics, or a combination thereof. The package can be in one or more pieces, for example, a bottom and top section, and optionally one or more side sections, that can be sealed together to enclose the display element and a humidistat material. The package can be sealed by adhesive, heat, ultrasonics, or other known sealing methods, including a combination thereof. The packaging can include the display drive source, the power source, or both. One or more sides of the package can be formed by the support, the protective layer of the display element, or the humidistat.

One or more humidistats can be located anywhere in the package, for example, above, below, to one or more side of the display element, or a combination thereof. The humidistat can be over the viewable portion of the display if the humidistat material is substantially transparent such that the display is readable through the humidistat. The humidistat can serve as a spacer to retain the display element or other features of the display in position in the package. For example, the humidistat can maintain the display area of the display element in a viewing window of the package.

For a bistable liquid crystal display, the relative humidity around the display element can be maintained at 40% or higher, for example, from 40-90%, from 50-80%, from 60-70%, from 60-65%, or, in some applications, from 70-90%, or higher than 80%. The desired relative humidity range can depend on the expected outside temperature range, including the amount and frequency of fluctuations, the desired power consumption, and the humidity range which achieves optimum viewability of the liquid crystal material. The humidistat material is chosen to maintain a desired relative humidity range. The humidistat can accommodate fast temperature changes to avoid formation of condensation in the package. Based on the bistable display material characteristics, power consumption, and expected environmental conditions, suitable humidistat materials and relative humidity ranges for various bistable display materials can be determined. Suitable materials and desirable relative humidity ranges can change based on expected external conditions. For example, packaging intended for use in a desert or artic environment will require a higher relative humidity than that intended for use in a marine environment.

Maintaining a constant relative humidity around the display element can provide consistent power consumption, reduced power consumption, improve viewability of the display, maintain consistent viewability over the life of the display, or a combination thereof. Higher relative humidities can accommodate a lower power consumption with good viewability. The display can have a power consumption of 110 volts or less, for example, 100 volts or less, 90 volts or less, 80-100 volts, or less than 80 volts, depending on the relative humidity around the display element.

The following examples illustrate the advantages of pairing a humidistat with a display element in a display, including improved viewability, controlled voltage, and lowered voltage requirements.

### EXAMPLES

In the following examples, a display device was used to illustrate the advantages of controlled humidity over uncontrolled humidity in the display device. The display element was a segmented display element as described herein. The display was programmed to display five digits or symbols to test each segment of the display.

For the experiments, one or both of humidity and voltage were controlled, and the contrast of the display was measured at each humidity/voltage combination. The experimental conditions were not able to generate voltages less than 85. The contrast was measured as brightness of the display as measured by a digital camera fitted with a photopic filter, divided by the darkness of the display. This method of measurement simulates the sensitivity of the human eye to contrast.

For each experiment, each display was conditioned at the test temperature and relative humidity in a Tenney environmental chamber (three feet by three feet by four feet high) for a minimum of four hours to allow the display to equilibrate to the relative humidity of the chamber by an exchange of moisture between the air and the materials of the display before measurements were taken. The Tenney environmental chamber provided a constant air temperature and humidity for conditioning and measurement of each display for each experiment. The temperature was maintained at 22 degrees Celsius for every display and experiment. The display was stored in a holder in the chamber during conditioning in such a way to allow air contact with both sides of the display. One display at a time was present in the chamber for testing.

After four hours conditioning, the display in the chamber was mounted into a nest in the chamber, and appropriate electrical contacts for driving the display were made to a power source and driver external to the chamber. The mounting of the display in the nest and connection to the driver and power source were accomplished by reaching through small portals in the chamber door. The small portals allowed display mounting without opening the doors of the environmental chamber, maintaining the controlled environment.

To determine contrast, a display was illuminated by two 11-inch by 14-inch 50 kHz fluorescent panels in the chamber. The two fluorescent panels were positioned and angled to diffusely illuminate the display, so that a black and white high-resolution camera mounted over the display in the chamber did not see the image of the light panels reflected off the surface of the display. The camera and light panels were located and fixed in position to avoid a specular reflection. The camera and light panels were fixed relative to the nest, and the position checked after each display was inserted into the nest.

The camera included a broadband photopic filter peaking at 530 nm to simulate the sensitivity of the human eye to brightness or luminosity. The camera was controlled by software to capture and record an image of each display. Specific areas of each display were analyzed digitally for a measure of brightness, on a 0 to 255 scale. This information was stored, and analyzed after the experiments were completed.

To measure the contrast, each display was subjected to a voltage for a time sufficient to drive the display into a planar (reflective) state or into a focal-conic (transmissive) state at that voltage. In the focal-conic state, incident light passed through the cholesteric liquid crystal material and was absorbed by the black layer backing the cholesteric liquid crystal material, making the display appear black. An automated measurement procedure randomly applied voltages to each display in 5 volt increments from 85 volts to 130 volts, i.e. 90 volts, 125 volts, 105 volts, etc. At the applied voltage, the display was put into the planar (bright) texture, the voltage removed, and the brightness measured. Then, at the same voltage, the display was driven into the focal-conic (dark) state, the voltage removed, and the brightness measured. The procedure was repeated on each display until all ten voltages (5 volt increments from 85 volts to 130 volts) were applied to each display and the results recorded.

Several grayscale Munsell targets of known percent reflectance were imaged in the same manner as the displays to calibrate the 256 levels of measurable brightness to a percent reflection. Each Munsell target was measured and converted into a value on the 0 to 255 brightness scale. The Munsell grayscale targets produced a calibration between the digital 256 brightness levels and percent reflectance. The calibration enabled conversion of display measurements into percent reflectance. The ratio of the measured reflectances of the planar to the focal-conic texture provided the contrast measurement for each display for each combination of relative humidity and voltage.

After a display was tested as above at a given humidity, the display was removed from its nest and placed in the holder. The setting for relative humidity was adjusted to a new value for the next sequence of measurements, and conditioning at the new humidity level commenced. After four hours, the display was placed in the nest again, and the contrast measurement procedure repeated.

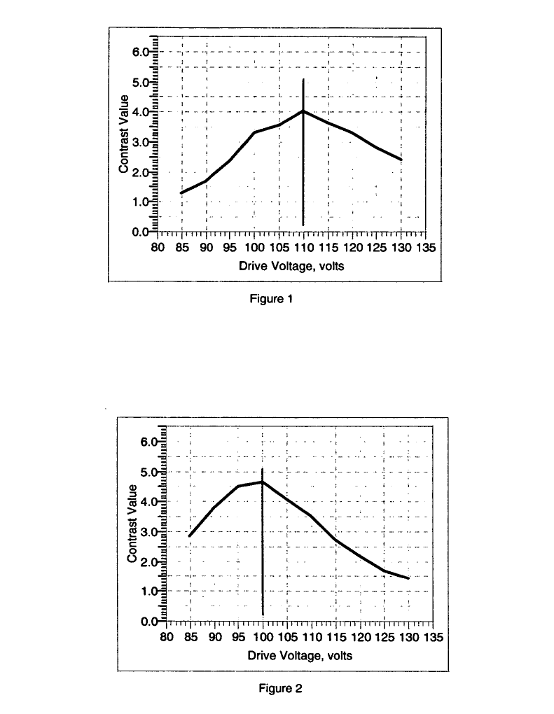

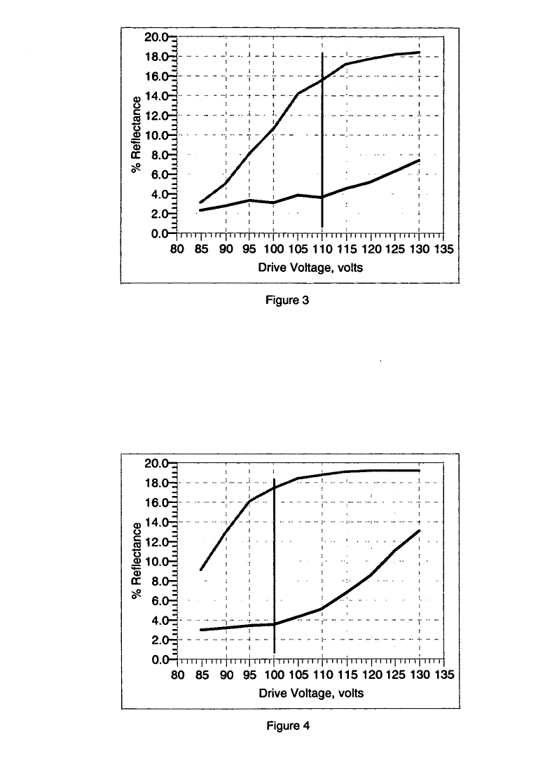

The above procedure was followed for the display at the relative humidities of 33% and 47%. A curve of contrast value versus drive voltage for the display element at 33% relative humidity is shown in FIG. 1, and at 47% relative humidity is shown in FIG. 2. The corresponding reflectance data showing reflectance in the planar and focal-conic states of the display is shown in FIG. 3 (33% relative humidity) and FIG. 4 (47% relative humidity).

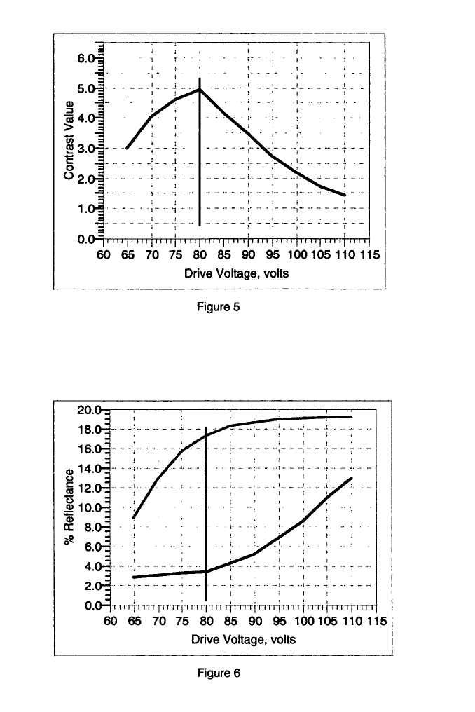

Extrapolating to relative humidities higher than 47% indicated that the range of drive voltages should extend below 85 volts for the sequence of measurements to calculate the curve of contrast versus drive voltage. In order to verify that higher relative humidity continues to lower drive voltage and increase contrast, the display was conditioned at 70% relative humidity for four hours. Removed from the environmental chamber, the display was quickly connected to a power supply and electronics that allowed the manual entry and application of a drive voltage. Manually changing the drive voltage and switching the display several times allowed a visual comparison to select the best contrast. The best visual contrast at 70% relative humidity occurred at a drive voltage of 80 volts, and was visually observed to be a higher contrast than the best contrast at 47% relative humidity. Using this base measure and extrapolating the 33% and 47% relative humidity curves, a curve of contrast value versus drive voltage was plotted for 70% relative humidity, as shown in FIG. 5. The corresponding reflectance values showing reflectance in the planar and focal-conic states of the display is shown in FIG. 6. From the above data, it was determined that a 15 volt decrease in drive voltage corresponded to an increase of 0.5 in contrast, resulting in a contrast of 5.0 at 80 volts at 70% relative humidity. Visually comparing the 47% and 70% relative humidity display elements showed that at a 70% relative humidity and at a drive voltage of 80 volts the contrast was improved. As seen in FIG. 1, for a constant humidity of 33%, the contrast peaks at 4.0 at a drive voltage of 110 volts. At 47% relative humidity, the contrast measurements peak at 4.6 at 100 volts, 10 volts lower than at 33% relative humidity, and with a higher contrast. At 47% relative humidity, the contrast measurement is 4.5 at 95 volts, 15 volts lower than at 33% relative humidity. The display could be operated at 95 volts at 47% relative humidity, instead of 100 volts, because the change in contrast is small: 4.5 versus 4.6 at 100 volts. The five volt decrease in drive voltage that can be achieved at 47% is important for extending battery life through lower power consumption. As seen in the Figures, higher contrast can be achieved at lower drive voltages when the relative humidity is high.

In FIGS. 3, 4, and 6 the vertical lines indicate the paired planar and the focal-conic reflectances for the corresponding peak contrast voltages for the relative humidities of 33%, 47%, and 70%, respectively. In FIGS. 3, 4, and 6, the upper line represents planar reflectance, and the lower line represents the focal-conic reflectance. The contrast values are the ratio of the paired reflectances, planar reflectance divided by focal-conic reflectance, as shown in FIGS. 1, 2, and 5, respectively. The peak contrast occurs at the drive voltage where the paired reflectances have the biggest difference. As can be seen from FIGS. 3, 4, and 6, an increase in relative humidity shifts the reflectance versus drive voltage curve toward lower voltages for both planar and focal-conic reflectance.

In the results shown in FIGS. 1, 2, and 5, and the Tables below, higher contrast numbers indicate better legibility and viewability of the display. Lower drive voltages indicate lower power consumption. For the “control” display C1-C3, internal and external relative humidity are considered to be the same, and correspond to the humidity setting of the chamber, as if the display in the chamber was not sealed form the environment. To illustrate the invention, the “inventive” display I1-I3 has an internal humidity with a value corresponding to the humidity setting of the chamber, and the external humidity (that outside the chamber) is presumed to have no effect on the display. For the inventive display, the chamber acts as a package with a humidistat surrounding the display, wherein the humidistat is selected for the given humidity.

Given the results of the above experiments and extrapolated contrast values for 70% relative humidity, the voltage level necessary to achieve a high display contrast was determined for each display at each given humidity level. The results are shown in Table 1.

TABLE 1

| | Relative | | | |
|---|---|---|---|---|
| | Humidity, | Relative Humidity, | Display | Corresponding |
| Display | External | Internal | Contrast | Drive Voltage |
| C1 | 33% | not controlled: 33% | 4.0 | 110 volts |
| C2 | 47% | not controlled: 47% | 4.5 | 95 volts |
| C3 | 70% | not controlled: 70% | 5.0 | 80 volts |
| I1 | 33% | controlled: 70% | 5.0 | 80 volts |
| I2 | 47% | controlled: 70% | 5.0 | 80 volts |
| I3 | 70% | controlled: 70% | 5.0 | 80 volts |

As can be seen from the control display C1-C3 in Table 1, the higher the humidity level, the better the contrast achieved. The higher humidity levels in the control display also required lower voltage to achieve the best contrast. The inventive display I1-I3 was able to achieve a high contrast with a low drive voltage at a high internal relative humidity, regardless of external relative humidity. From the results achieved, it is expected that an even lower voltage than 80 volts could be used to obtain the same or higher contrasts in the inventive display by holding the internal relative humidity at higher values than 70% relative humidity.

The advantage of the inventive display controlled to 70% internal relative humidity over the control display run at 70% internal and external relative humidity is that the inventive display maintains the humidity of the display element regardless of outside humidity, therefore maintaining a constant contrast and viewability at a given voltage. This would be achieved by including a humidistat with the desired humidity level in a package with the display. When both humidity and voltage of the display element are allowed to change, the desirable voltage must be varied dependent on the humidity to achieve good contrast.

If constant voltage is maintained, the relative humidity affects the contrast as shown in Table 2, where the contrast is given at each relative humidity for a voltage of 80 volts, which value is extrapolated from FIGS. 1, 2, and 5.

TABLE 2

| | Relative | | | |
|---|---|---|---|---|
| | Humidity, | Relative Humidity, | Display | Corresponding |
| Display | External | Internal | Contrast | Drive Voltage |
| C1 | 33% | not controlled: 33% | 1.0 | 80 volts |
| C2 | 47% | not controlled: 47% | 2.0 | 80 volts |
| C3 | 70% | not controlled: 70% | 5.0 | 80 volts |
| I1 | 33% | controlled: 70% | 5.0 | 80 volts |
| I2 | 47% | controlled: 70% | 5.0 | 80 volts |
| I3 | 70% | controlled: 70% | 5.0 | 80 volts |

As shown in Table 2, at a constant voltage of 80 volts, the contrast of the control display dropped sharply as internal humidity dropped, while the inventive display maintained a high contrast with a controlled high relative humidity. The humidity of the external environment effects the control display, changing the contrast at a given voltage. Constant voltage draw is desirable to provide a steady power supply with a known life span at the given voltage. Controlling the relative humidity of the display element allows a constant power supply of known voltage and a given life span to be supplied for the display, which in turn provides a consistent, known contrast over the life of the display.

If a desired contrast is wanted, voltage and relative humidity of the display can be controlled to achieve the desired contrast. For example, if a contrast of 4.0 is desired, it can be achieved as follows: at 33% relative humidity, a voltage of 110 volts; at 47% relative humidity, a voltage of 92 or 106 volts; or at 70% relative humidity, a voltage of 69 or 87 volts. The same contrast can be achieved at lower voltages with a higher controlled relative humidity, as shown in the FIGS. 1, 2, and 5.

The inventive display controls humidity around the display element to a desired level, allowing control of the drive voltage and/or contrast of the display to desired levels. By changing the humidity or voltage, the contrast of the display can be adjusted. A desired contrast can be achieved by changing the voltage, the humidity level, or both. The invention enables greater control of contrast and voltage requirements for a display by changing the humidity of the display element independent of the external relative humidity. The ability to control voltage requirements can increase power source life by the use of lower voltages, while maintaining the humidity level can also increase power source life by drawing a consistent amount of power from the power source. By increasing power source lifespan, costs of the display can be lowered, lifespan of the display can be increased, or a combination thereof.

The invention has been described in detail with particular reference to certain preferred embodiments thereof, but it will be understood that variations and modifications can be effected within the spirit and scope of the invention.

1. A bistable display comprising a display element including at least one layer of bistable material, and a humidistat.

2. The display of claim 1, wherein the humidistat maintains a constant relative humidity of at least at 40 percent.

3. The display of claim 1, wherein the humidistat maintains a constant relative humidity of 60 percent or greater.

4. The display of claim 1, wherein the humidistat maintains a constant relative humidity of 70 percent or greater.

5. The display of claim 1, wherein the humidistat maintains a constant relative humidity of between 70 percent and 90 percent.

6. The display of claim 1, wherein a voltage to drive the display is less than or equal to 110 volts.

7. The display of claim 1, wherein a voltage to drive the display is less than or equal to 95 volts.

8. The display of claim 1, wherein a voltage to drive the display is less than or equal to 80 volts.

9. The display of claim 1, wherein the display further comprises a package enclosing the display element and humidistat.

10. The display of claim 9, wherein the package further encloses a power source.

11. The display of claim 9, wherein the package comprises a material with a low water vapor transmission rate.

12. The display of claim 1, wherein the display element further includes a substrate.

13. The display of claim 12, wherein the substrate is the humidistat.

14. The display of claim 1, wherein the humidistat further includes a moisture barrier on one side of the humidistat.

15. The display of claim 1, wherein the bistable material is a liquid crystal material.

16. The display of claim 1, wherein the bistable material is a chiral nematic liquid crystal material.

17. The display of claim 1, wherein the display has a consistent contrast greater than 3.0.

18. The display of claim 1, wherein the display has a consistent contrast greater than 4.0.

19. The display of claim 1, wherein the humidistat comprises magnesium acetate.

20. A method of reducing a voltage driving requirement of a bistable display comprising a display element including at least one layer of bistable material, the method comprising adding a humidistat to the bistable display.

21. The method of claim 20, wherein the bistable display comprises a liquid crystal material.

22. The method of claim 20, further comprising controlling the relative humidity within the display to a constant relative humidity of at least 40 percent.

23. The method of claim 20, further comprising controlling the relative humidity within the display to a constant relative humidity of at least 60 percent.

24. The method of claim 20, wherein the humidistat comprises magnesium acetate.

25. A method of controlling contrast of a bistable display comprising a display element including at least one layer of bistable material, the method comprising adding a humidistat to the bistable display.

26. The method of claim 25, further comprising controlling the relative humidity within the display to a constant relative humidity of a predetermined value.

27. The method of claim 26, wherein the humidity is controlled to within +5% relative humidity of the predetermined value.

28. The method of claim 25, wherein the humidistat comprises magnesium acetate.
